(19) United States
(12) Patent Application Publication
(10) Pub. No.: US 2023/0110519 A1
(43) Pub. Date: Apr. 13, 2023

(54) LENS EXAMINATION METHOD AND APPARATUS

(71) Applicant: EYOTO GROUP LIMITED, Birmingham, West Midlands (GB)

(72) Inventors: Michal KRAWCZYNSKI, Birmingham (GB); Joseph DAVIES, Birmingham (GB); Suraj SUDERA, Birmingham (GB)

(21) Appl. No.: 17/802,860

(22) PCT Filed: Feb. 22, 2021
(86) PCT No.: PCT/GB2021/050432

§ 371 Date: Aug. 26, 2022

(30) Foreign Application Priority Data
Feb. 28, 2020 (GB) 2002857.7

(51) Int. Cl. G01M 11/02

(52) U.S. Cl. CPC G01M 11/0228; G01M 11/0214

(57) ABSTRACT

A test pattern is displayed on a planar display surface 14. The power of a test lens 20 is determined by measuring the magnification of the test pattern as seen through the test lens with the test lens at two different lens distances dl¹, dl² from the display surface and calculating the power from the two magnification values and the difference in lens distance Δdl. Apparatus for carrying out the method includes a digital display screen 14 for displaying the test pattern and a digital camera 16 for capturing images of the test pattern through a test lens 20. The apparatus has a lens carriage 18 in which a test lens 20 is mounted to hold the test lens between the display screen and the camera. The lens carriage 18 is movable under control of an electronic control system 28 in a linear direction perpendicular to the display screen to vary the distance between the test lens and the display screen.

### TECHNICAL FIELD OF THE INVENTION

The invention relates to a method and apparatus for examining lenses and especially, but not exclusively, ophthalmic lenses.

### BACKGROUND TO THE INVENTION

It is often necessary to be able to determine the optical parameters of a lens such as those used in glasses. This may be required as part of the manufacturing process to ensure a lens conforms to the prescription and may be carried out either before the lens has been assembled into a glasses frame or after. It is also sometimes necessary to determine the optical parameters of a lens in a pair of glasses which have been used, say as part of an ophthalmic examination where the person does not have their prescription to hand or to check that the lens is in conformity with their prescription. The present invention in its various aspects provides several new approaches to these operations, reducing substantially the reliance upon skilled personnel to carry out the tasks. This is particularly important in areas where there is a shortage of such skills.

Lensmeters are known which are able to automatically determine the power of a glasses lens. In one known arrangement, a test pattern is displayed on a digital screen, a lens is positioned between the screen and a digital camera and an image of the test pattern as seen through the lens under test (herein referred to as the “test lens”) is captured by the camera in a “lens image”. The test pattern will usually be distorted by the test lens, unless the test lens is plain, and by comparing the distorted test pattern captured in the lens image with the original test pattern it is possible to determine the magnitude of magnification M produced by the test lens. If the distance dₒ between the test lens and the display screen is known, the power (P) of the test lens can be calculated using a function f(M)=P, where the function f is determined for any given apparatus from a set of standard lenses of known dioptric power (D). The image processing and analysis is usually carried out by a computing means running appropriate software and the system is calibrated to take the effects of the camera and other parts of the apparatus into account.

In WO 2018/073577A2, we described a method of determining the power of a test lens using a test pattern comprising a set of dots arranged so that they can be joined by a unique first ellipse of best fit. When viewed though a test lens, the size and spacing between the dots will change depending on the magnification and by analysing these changes the magnitude magnification and hence the power of the test lens can be determined. Conveniently, the change in spacing between the dots in the set is analysed by producing a second ellipse of best fit for the set of dots in the lens image and comparing the major and minor axes of the second ellipse of best fit with those of the first. This test pattern can also be used to determine whether the test lens includes astigmatic correction (cylindrical power) and, if so, the axis angle of the astigmatic correction. In the original test pattern, the dots are arranged on a circle so that in the first ellipse of best fit the major and the minor axes are the same. If the test lens is cylindrical, the relative positions of the dots will change when viewed through the test lens so that the major and minor axes of the second ellipse of best fit will not be the same. By analysing differences in the major and minor axes of the first and second ellipses of best fit, the cylindrical power and the axis angle of any astigmatic correction can be determined as well as the magnitude of magnification.

In many glasses lenses, such as varifocal lenses for example, power and other optical characteristics vary across the lens. In order to determine the power of a glasses lens at multiple points across the test lens at the same time, we disclosed in WO 2018/073577A2 an embodiment in which the test pattern comprises an array of dots arranged to define multiple overlapping sets of dots, each of which sets can be joined by an ellipse of best fit as described above. Using this test pattern, a glasses lens can be analysed to determine its power and any astigmatic correction at a large number of positions at the same time from a single lens image and the results presented in the form of a contour map of power and/or astigmatic correction across the test lens.

The known method of determining the power of a test lens produces accurate results if the object distance (dₒ) is accurately known. Classically, object distance is measured from the first principal plane of the lens. Principal planes are hypothetical approximations used for calculating lens parameters. Whilst these approximations hold well for simple lenses, they are difficult apply to more complex lenses. For progressive lenses with a complex shape, it may not be possible to define a principal plane for the lens. For such lenses, accurately determining the object distance for any given position across the lens is difficult. Some known lensmeters use a Shack-Hartmann wave front sensor to measure the power of a lens but this often limits the measurement to a small section of the lens and requires knowledge of the distance from the lens to the sensor

Furthermore, the known method requires the function f to be determined from a set of standard lenses of known dioptric power and each lensmeter requires a unique calibration transform algorithm which is applied to the test pattern in the lens image to remove distortions to the test pattern produced by the apparatus rather than the lens. Each of these requirements adds to inaccuracies in the overall system, whilst use of a calibration transform algorithm also adds to the processing requirements.

The present invention seeks to overcome or at least mitigate some or all of the drawbacks of the known methods and apparatus for determining the power of a lens.

### SUMMARY OF THE INVENTION

According to a first aspect of the invention, there is provided a method of determining the power of a test lens, the method comprising:
a. displaying a test pattern on a planar display surface;
b. positioning a test lens between the display surface and a digital camera at a first position where the test lens is at a first lens distance from the display surface and using the camera to capture an image of the test pattern as seen through the lens at the first position (“the first lens image test pattern”);
c. positioning the test lens between the display surface and the camera at a second position where the test lens is at a second lens distance from the display surface different from the first lens distance and using the camera to capture an image of the test pattern as seen through the test lens at the second position (“the second lens image test pattern”);
d. analysing each of the first and second lens image test patterns to determine the magnitude of magnification M₁ of the test pattern at the first position and the magnitude of magnification M₂ of the test pattern at the second position M₂;
e. calculating the power P of the test lens from the magnification values M₁, M₂ at the first and second positions and the change in lens distance Δdl between the first and second positions.

The term “lens distance” as used herein, including in the claims, refers to the distance between any given reference point in or on the test lens and the display surface when measured in a direction perpendicular to the plane of the display surface. It can be helpful to think in terms of the lens distance being the distance between the display surface and a reference plane extending parallel to the display surface and which passes through the refence point. In a simple lens at least, a suitable reference plane would extend orthogonal to an optical or principal axis of the test lens. However, in practice it is not essential to actually identify such a reference plane or to measure the actual distance between the display screen and the reference plane as the change in lens distance Δdl can be determined from the movement of the test lens between the first and second positions. For example, the change in lens distance Δdl can be determined with relative accuracy by incorporating into apparatus for carrying out the method a mechanism for accurately moving the test lens by a set distance perpendicular to the plane of the display surface between the first and second positions and/or by incorporating a means to determine, measure, detect or sense, either directly or indirectly, the distance moved by the test lens between the first and second positions. Provided the test lens is held in the same orientation relative to the display surface as it is moved between the first and second positions, the change in lens distance Δdl will be same for all points in the test lens regardless of the shape of the lens. The inventive method therefore eliminates inaccuracies in calculating the power at multiple positions across a glasses lens which would otherwise arise due to difficulties in accurately determining the object distance across the lens. Further advantages are that the calculation does not require a function to be determined using a set of standard lenses of known dioptric power and that a calibration transformation algorithm is not usually required.

The power P of the test lens can be determined using the following equation or an equivalent:

$$\text{P=} \frac{1}{f} = \frac{\frac{1}{{M}_{1}} - \frac{1}{{M}_{2}}}{Δ d l}$$

Where M₁ and M₂ are the values of the magnification of the test pattern measured with the test lens at the first and second positions respectively and Δdl is the change in lens distance between the first and second positions.

In an embodiment, the test lens is moved in a direction X perpendicular to the display screen between the first and second positions. Typically, this direction will be coincident with, or at least parallel to, the optical axis of the camera lens, which is generally aligned perpendicular to the display surface passing through the lens under test.

The method may comprise moving the test lens a predetermined distance Δdl from the first position to the second position. Alternatively, the method may comprise determining the degree of magnification of the test pattern caused by the test lens at the first position and moving the test lens from the first position until a second position is reached at which the change in magnification of the test pattern caused by the test lens is at or above a pre-determined amount suitable to enable the power of the test lens to be calculated and to determine the distance moved by the test lens from the first position to the second position. The method may comprise monitoring the position of a reference point on the test lens, either directly or indirectly, in order to determine the change in lens distance Δdl between the first and second positions. The method may comprise mounting the test lens in a lens carriage for holding the test lens between the display surface and the camera wherein the lens carriage is movable relative to the display surface in said linear direction perpendicular to the display surface. In this embodiment, the method comprises moving the lens carriage in said linear direction to place the test lens at the second position after the first lens image test pattern has been captured. The method may also comprise determining the change in lens distance Δdl from the movement of the lens carriage. The lens carriage may be part of a lens movement system comprising an electronic actuator operating under the control of an electronic control system for controlling movement of the lens carriage. The actuator may comprise a stepper motor and the method may comprise determining the change in lens distance Δdl by monitoring the number of steps taken by the motor to move the lens carriage from the first position to the second position. The stepper motor may drive a threaded shaft of known pitch to which the lens carriage is mounted by way of a drive nut.

The method may comprise mounting one or more test lenses directly on the lens carriage. Alternatively, the method may comprise mounting a pair of test lenses in a glasses frame on the lens carriage.

The method may comprise determining the magnitude of magnification M₁, M₂ of the test pattern at the first and second positions by comparing each of the first and second lens image test patterns with the original test pattern.

The method may comprise displaying a test pattern comprising at least one set of dots arranged so that the dots in the set can be joined by a first, unique ellipse of best fit, the magnitude of magnification at each of the first and second positions being determined by deriving a second ellipse which is an ellipse of best fit joining the dots in said at least one set of dots in each of the respective first and second lens image test patterns and comparing each of the second ellipses of best fit with the first ellipse of best fit. The method may comprise determining the major axis and the minor axis of the second ellipses and comparing these with the major axis and the minor axis respectively of the first ellipse to determine the magnification.

In one embodiment, the method is used to determine the lens power at a single point in the test lens, the method comprising aligning the optical centre of the test lens with the optical axis of the camera lens and with the centre of one of said at least one sets of dots before capturing the lens images.

In an alternative embodiment, the method is used to determine the lens power at multiple positions across an area of interest of the test lens, the method comprising:

displaying a test pattern comprising a plurality of said sets of dots distributed over an area of the display surface and determining the magnitude of magnification in respect of each of said sets of dots in the test pattern recorded in the respective first and second lens image test patterns within the area of interest of the test lens and calculating a value for the lens power in respect of each set of dots.

The area of interest may comprise substantially the whole of the test lens.

The test pattern may comprise a plurality of dots arranged in an array of rows and columns, wherein the dots in each row are equally spaced apart by a distance which is equal to the spacing between adjacent rows, and wherein alternate rows are off-set so that the dots in any given row lie midway between the dots in an adjacent row or rows, such that each dot (other than those at the edges of the array) is surround by six other dots located at the apexes of a notional regular hexagon, wherein each set of six other dots comprises one of said sets of dots.

The method may comprise using an electronic display screen to display the test pattern. The camera and the screen may be operatively connected to a computing device and the method may comprise using the computing device to generate the test pattern, to carry out the required image processing and analysis, and to control movement of the lens carriage.

In accordance with a second aspect of the invention, there is provided apparatus for determining the power of a test lens, the apparatus comprising a planar display surface for displaying a test pattern, a digital camera having a lens whose optical axis is aligned perpendicular to the display surface, a lens carriage for holding a test lens between the display surface and the camera lens, the lens carriage being movable in a linear direction perpendicular to the display surface to vary the distance between the test lens and the display surface, the apparatus including an electronic control system for controlling movement of the lens carriage in said linear direction.

The apparatus may comprise an electronic actuator operating under the control of the electronic control system for controlling movement of the lens carriage. The actuator may comprise a stepper motor. The apparatus may comprise a system for measuring or detecting the distance moved in said linear direction by the lens carriage. The apparatus may be configured in use to move the lens carriage to a first position in which a test lens mounted to the carriage is at a first lens distance relative to the display surface and to subsequently move the lens carriage to a second position in which the test lens is at a second lens distance relative to the display surface different from the first lens distance.

The apparatus may be configured to use the digital camera to capture an image of the test pattern as seen through the test lens by the camera when the lens carriage is at the first position (“the first lens image test pattern”) and to capture a further image of the test pattern as seen through the test lens by the camera when the lens carriage is at the second position (“the second lens image test pattern”) and to analyse each of the first and second lens image test patterns to determine the magnitude of magnification of the test pattern when the test lens is at the first position and the second position respectively.

The apparatus may be configured to move the lens carriage by pre-determined distance perpendicular to the screen between the first and second positions. The apparatus may be configured to move the lens carriage from the first position until a second position is reached at which the change in magnification of the test pattern is at or above a pre-determined amount suitable for calculating the power of the test lens and to determine the distance moved by the carrier from the first position to the second position.

The apparatus may comprise a computing device which forms part of or is associated with the electronic control system and which computing device is programmed to carry out the image data processing and analysis steps for determining the magnitude of magnification of the test pattern caused by the test lens at the first position and the second position.

The lens carriage may be adapted to receive one or more test lenses individually.

The lens carriage may be adapted to mount a pair of test lenses in a glasses frame.

The apparatus may be a lensmeter.

The apparatus may be configured to carry out the method according to the first aspect of the invention.

In accordance with a third aspect of the invention, the apparatus according to the second aspect of the invention is used to carry out the method according to the first aspect of the invention.

### DETAILED DESCRIPTION OF THE INVENTION

In order that the invention in its various aspects may be more clearly understood one or more embodiments thereof will now be described, by way of example only, with reference to the accompanying drawings, of which:

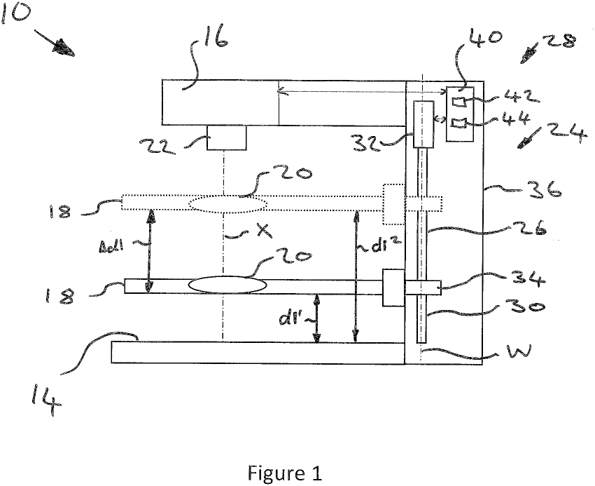

FIG. 1 is a schematic side view of a first embodiment of apparatus for determining the power of a test lens in accordance with an aspect of the invention;

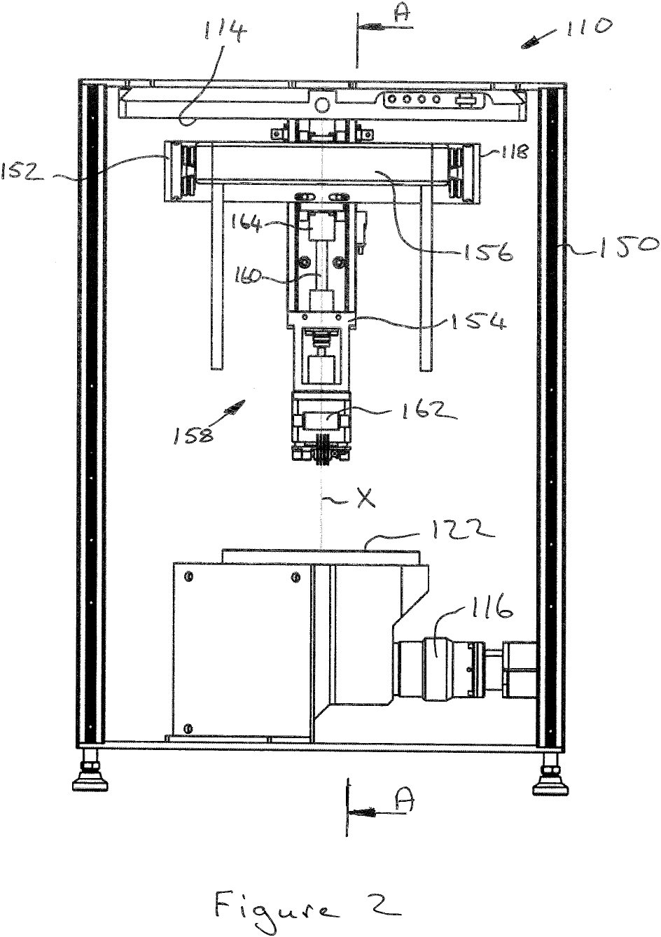

FIG. 2 is a view from the front of a second embodiment of apparatus for determining the power of a test lens in accordance with an aspect of the invention, with outer casing elements of the apparatus removed so show the internal detail;

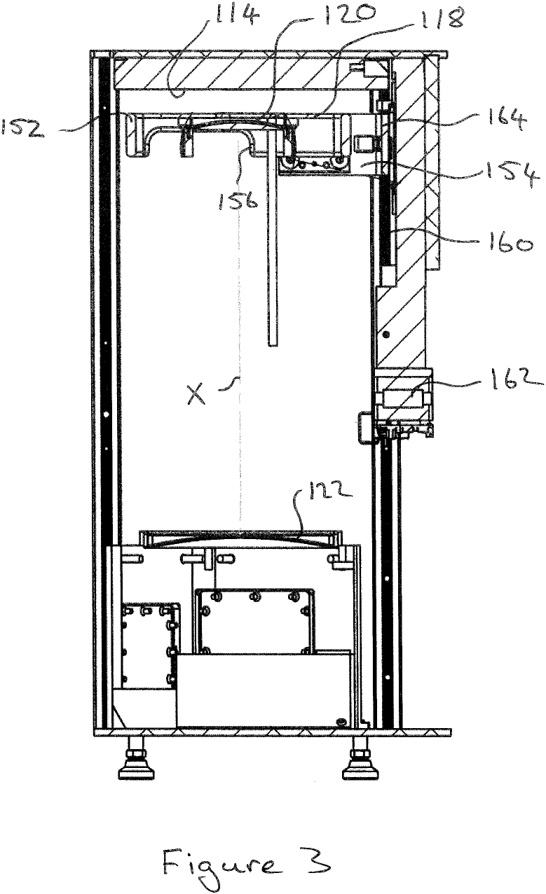

FIG. 3 is a cross-sectional view through the apparatus of FIG. 2 taken on line A-A;

FIG. 4 is a composite drawing including two side views of the apparatus of FIGS. 2 and 3 illustrating the apparatus holding a test lens at two different measurement planes relative to a display screen;

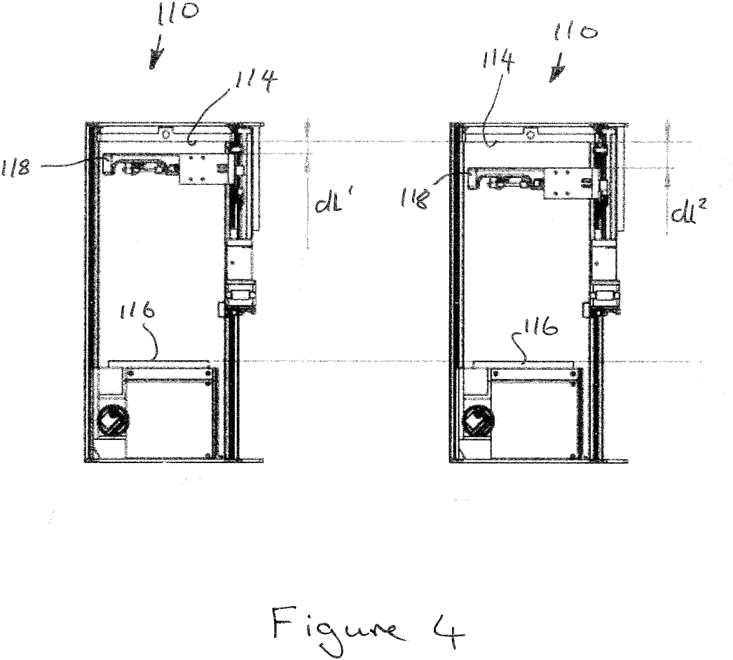

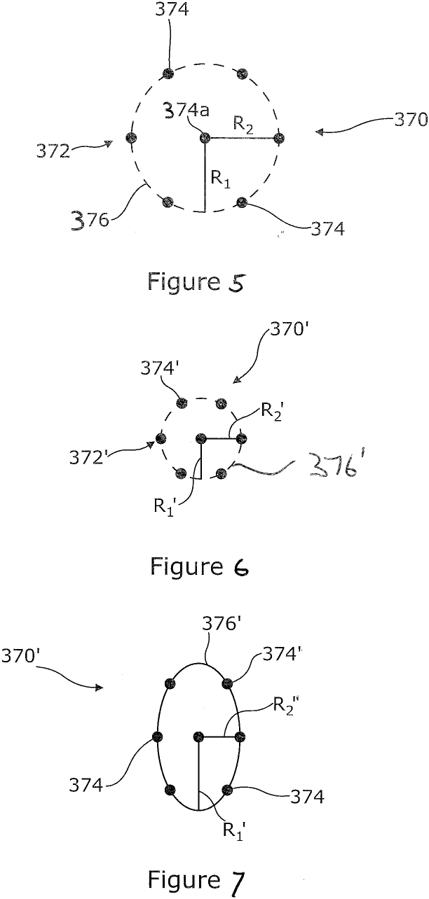

FIG. 5 is a schematic representation of an original test pattern for use in the method of determining the power of a test lens in accordance with an aspect of the invention;

FIG. 6 is a view similar to that of FIG. 5 but illustrating how the test pattern may be distorted through a spherical lens;

FIG. 7 is a view similar to that of FIG. 5 but illustrating how the test pattern may be distorted through a cylindrical lens; and

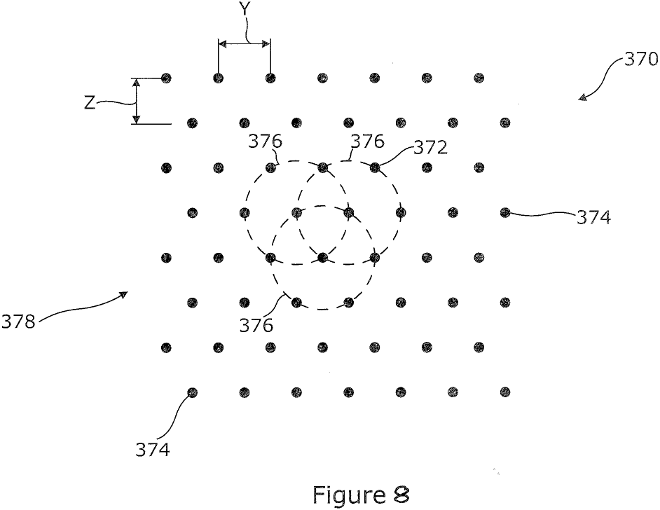

FIG. 8 is a schematic representation of an alternative original test pattern for use in use in the method of determining the power of a lens in accordance with an aspect of the invention.

The method of determining the power (P) of a test lens in accordance with the invention uses magnification data collected with the test lens at two different measurement planes spaced from but parallel to the display surface where the distance between the planes is known. Knowing the magnification caused by a test lens in a first plane (Mi) and a second plane (M₂) and the distance between the planes (Δ6dl), the power of the test lens (P) can be calculated from the formula shown below:

$$P = \frac{1}{f} = \frac{\frac{1}{{M}_{1}} - \frac{1}{{M}_{2}}}{Δ d l}$$

This method works on the basis that if the object distance is treated as an unknown, determining the magnification caused by a test lens at two object distances gives two equations and two unknowns - the lens power and the object distance. These two equations can be solved simultaneously to derive the lens power without the need to know the object distance, provided that the difference between the object distances at the two measurement planes is known. In the present method, the change in lens distance Δdl between the measurement planes or positions is equivalent to the change in object distance Δdₒ at all points across the test lens. Accordingly, the change in lens distance Δdl can be substituted in place of the change in object distance Adₒ to calculate the power of the test lens.

If we use the thin lens equation and substitute the image distance (dᵢ) with the rearranged magnification equation, then we can describe the power of the test lens in a first measurement plane as:

$$\frac{1}{f} = \frac{{M}_{1} - 1}{d o {M}_{1}}$$

If we then move the test lens a distance Δdl to a second measurement plane, the power of the test lens can be described in the second measurement plane as:

$$\frac{1}{f} = \frac{- 1}{\left(d o + Δ d l\right) {M}_{2}}$$

Rearranging equation 2 to make do the subject and substituting it into the equation 3 allows us to describe the test lens as:

$$f = \frac{1}{P} = \frac{{M}_{2} Δ d l}{\left(\left({M}_{2} - 1\right) - \frac{{M}_{2} \left({M}_{1} - 1\right)}{{M}_{1}}\right)}$$

Where M₁ and M₂ are the measured magnifications at the first and second measurement planes respectively and Δdl is the difference between the lens distance at the two measurement planes, e.g. the distance between the measurement planes.

Equation 4 can be rearranged to give the power of the lens as in equation 1.

An apparatus 10 for carrying out the method is illustrated schematically in FIG. 1. The apparatus 10 is in the form of a lensmeter and comprises a digital screen 14 for displaying a test pattern, a digital camera 16 for capturing images of the test pattern and a lens carriage 18 having a mounting arrangement for holding a lens 20 which is under examination (referred to as a “test lens”) so that the test lens is positioned between the digital screen 14 and the lens 22 of the camera. FIG. 1 shows the lens carriage 18 and the test lens 20 in a first position or first measurement plane in solid lines and in a second position or second measurement plane in broken lines.

The display screen 14 is typically a planar display panel and could be an LCD type display panel. The camera 16 is located so that the optical axis X of the camera lens 22 is perpendicular to the display screen 14. The lens carriage 18 is arranged to hold the test lens 20 between the camera and the display screen so that the optical axis X of the camera passes through the test lens at or close to its optical centre.

The lens carriage 18 is movable relative to the camera 16 and the display screen 14 in a linear direction perpendicular to the display screen and parallel to the optical axis X of the camera. This movement of the lens carriage 18 enables the distance between the test lens 20 and the display screen 14 (the lens distance dl) to be varied whilst maintaining the orientation of the test lens 20 relative to the display screen 14 constant. In this embodiment, a suitable reference plane for determining lens distance dl is defined where the front face of a test lens engages with the carriage.

The lens carriage 18 forms part of a lens movement system (indicated generally at 24) which includes an electronic actuator 26. Operation of the lens movement system 24 is controlled and regulated by an electronic control system forming part of the apparatus and which is indicated generally at 28. In one embodiment, the actuator comprises a screw threaded rod 30 aligned with its longitudinal axis W parallel to the optical axis X of the camera and a stepper motor 32 for driving rotation of the rod. The lens carriage 18 includes threaded nut 34 which is engaged on the rod and prevented from turning so that rotation of the rod 30 by the stepper motor 32 causes the lens carriage 18 to move in a linear direction along the length of the rod. The actuator arrangement is housed in a body portion 36 of the apparatus to one side of the display screen 14. The carriage 18 will move by a set linear distance along the axis W of the shaft for each step of the motor, which distance can be calculated from the pitch of the thread.

The electronic control system 28 includes a computing device 40 having memory 42 and processing means 44 for carrying out processing steps in accordance with programmed algorithms. The apparatus 10 is configured so that the control system 28 is able to determine the distance moved by the lens carriage 18 in the linear direction when the actuator is actuated. In the present embodiment, the lens carriage 18 will be moved by a known amount in the linear direction for every step of the stepper motor so that the distance moved by the lens carriage can be calculated by monitoring the number of steps made by the stepper motor. The apparatus may include a means for determining when the lens carriage 18 is in a datum position relative to the rod so that the actual position of the lens carriage along the rod 30 can be determined by dead reckoning from the datum position. This might include a sensor for detecting when the lens carriage is at a particular position relative to the rod and can be used to determine at least approximately the lens distance dl.

It will be appreciated that there are many other mechanisms which could be adopted to move the lens carriage in a linear direction perpendicular to the display screen and to determine the distance moved by the lens carriage and that any suitable actuator arrangement can be adopted in apparatus according to the invention. Alternative arrangements for determining the distance moved by the lens carriage 18 can make use of any known sensor arrangement including, but not limited to, linear position sensors such as a potentiometer or a liner incremental encoder. Alternatively, the apparatus 10 could use a sensor arrangement for detecting the position or movement of the test lens 20 itself.

The camera 16 is operatively connected with the control system 28 and computing device 40 so that image data captured by the camera can be saved for processing and analysis and to allow control of the camera 16 by the control system 28. The computing device 40 is programmed to carry out the required image processing and computational analysis on the image data to determine the magnification values Mi and M₂ from the first and second lens image test patterns, to determine the change in lens distance Δdl, and to calculate the power of the test lens from these values.

In use, a test lens 20 is placed in the lens carriage 18 so that it is aligned between the camera and the display screen 14 on the optical axis X of the camera. A suitable test pattern is displayed on the screen 14 and the lens carriage 18 moved to a first position or measurement plane (indicated in solid lines in FIG. 1) at which the test lens is at a first lens distance dl¹ from the display screen. With the test lens at the first position, an image of the displayed test pattern seen through the test lens is captured by the camera in a first lens image (the first lens image test pattern) and the first lens image test pattern is analysed by the computing device to determine the magnitude of magnification M1 caused by the test lens at the first position.

The lens carriage 18 is then moved to place the test lens at a second position or measurement plane (as shown in dashed lines in FIG. 1) at which it is at a second lens distance dl² from the screen 14. With the test lens at the second position, a second image of the displayed test pattern as seen through the test lens is captured by the camera in a second lens image (the second lens image test pattern) and the second lens image test pattern image analysed by the computing device 40 to determine the magnitude of magnification M₂ of the test pattern caused by the test lens at the second position.

The computing device 40 determines change in lens distance Δdl between the first and second positions, e.g. by monitoring the number of steps taken by the stepper motor, and calculates the power of the test lens from the values for M₁, M₂ and Δdl using the methodology previously described, such as equation 1.

It will be appreciated that the various steps in the method need not be carried out in the exact sequence set out. For example, analysis of the first and second lens images to determine values for M₁ and M₂ could be carried after both have been captured, especially where the lens carriage 18 is moved through a set distance between the first and second positions.

In the method as described, it is not necessary to know the lens distances at the first and second positions, provided the change in lens distance is known. In the present embodiment, the apparatus is able to determine with accuracy the vertical distance moved by the lens carriage, and hence all points in the test lens, between the first and second positions by monitoring the steps taken by the stepper motor to determine the exact change in lens distance Δdl. However, other arrangements for measuring or determining the change in lens distance Δdl between the first and second positions can be adopted. It will be appreciated that use of the apparatus and methods disclosed do not actually require a specific reference point on the test lens or a refence plane to be identified as such since monitoring or measuring movement of the carriage between the first and second positions is sufficient to demine the change in lens distance for all points in the test lens.

Whilst it is not essential to know the first and second object distances, the principle of determining the power of a test lens by measuring magnification M₁, M₂ at two different measurement planes or lens distances depends on the ability to distinguish between the magnifications caused by the test lens at the two lens distances. Tests have found that for the majority of prescription lenses used in glasses, say ~+10 to -15 D, a suitable change in magnification is achieved if the first measurement is taken with the carriage 18 positioned so that the reference plane where the front face of the test lens engages the carriage is located at a distance in the range of about 15 mm to 39 mm from the display screen and the carriage moved further away from the screen through a distance in the range of 10 to 40 mm to the second position. However, it has been found that high powered lenses above about +15 D cause an image inversion when the lens distance approaches 60 mm. In such cases, it is envisioned that first and second positions where the reference plane is spaced from the display screen by around 20 mm and 35 mm respectively may be adopted. Suitable first and second positions for any given test lens can be established through trial and error and it will be appreciated that the exemplary first and second positions could be reversed.

In an alternative embodiment, rather than moving the lens carriage 18 through a pre-determined distance Δdl from the first to the second position, the apparatus may be configured to move the lens carriage 18 to a second position in which a sufficient change in magnification is present to enable the power of the test lens to be calculated and to determine the change in lens distance between the first and second positions. This can be an iterative process in which the apparatus moves the carriage from the first position by an initial amount and, if the degree of change of magnification is not sufficient, moves the carriage by a further amount and so on until a suitable second position is established.

The lens carriage 18 may be adapted to mount one or more individual lenses or to mount a pair of lenses in a glasses frame. In the latter case, the lens carriage 18 may have a glasses clamp which grips the frame and/or edges of the lenses and holds one of the lenses in the correct position to be examined. The glasses clamp may be rotatable so that after examination of a first test lens, the clamp is rotated to position the other test lens in the correct position for examination. Alternatively, the apparatus 10 may have two cameras 16 arranged so that both test lenses can be examined at the same time.

The display screen 14 is dimensioned so that the camera 16 does not see outside the screen, or at least an area of the screen where the test pattern is displayed, when viewed through the test lens at either of the first and second positions. In one embodiment, the display screen is an LCD panel having an aspect ratio of 16:9 with a monitor area of 275 x 159 mm.

FIGS. 2 to 4 illustrate an alternative embodiment of apparatus 110 which can be used to carry out the method of determining the power of a test lens according to the invention. The apparatus according to the second embodiment 110 is similar to that of the previous embodiment and features of the apparatus 110 in accordance with the second embodiment which are the same as, or which perform the same function as, features of the first embodiment are given the same reference numeral but increased by 100.

The apparatus 110 in this embodiment comprises a supporting structure 150. A digital camera 116 is mounted at the base of the supporting structure. The camera 116 has a lens 122, whose optical axis X is aligned vertically upwards. A high definition display screen 114 for displaying test patterns is mounted to the supporting structure in an upper region above the camera lens 122. The display surface of the screen 114 faces the camera lens 122 and is aligned horizontally, perpendicular to the optical axis X of the camera lens. The camera and the display screen are configured so that the optical axis X of the camera lens is aligned substantially at the centre of the display screen 114.

The display screen 114 in this embodiment is a high-definition (4k plus) LCD panel whilst the digital camera 116 has a CMOS image sensor and the camera lens 122 is a telecentric lens. However, other types of electronic display screen and digital imaging technology can be adopted.

A lens carriage 118 is located between the camera lens 122 and the display screen 114 for holding a test lens 120 in an appropriate orientation for measuring its power using the method of the invention. The lens carriage 118 includes a female cartridge 152 mounted to a stage 154 and a male cartridge 156 removably engageable in the female cartridge. The male cartridge 156 includes a mounting arrangement for holding a test lens 120. In use, the male cartridge 156 can be fully or partially removed from the female cartridge 152 to allow test lenses 120 to be mounted and removed and is inserted in the female cartridge when a test lens 120 is mounted ready for examination. The lens carriage 118 is configured to hold a test lens 120 between the camera lens 122 and the display screen 114 with the test lens 120 broadly concentric with the camera lens 122. The male and female cartridges 152, 156 have apertures arranged so that a test pattern displayed on the screen 114 can be seen through the test lens 120 by the camera.

The stage 154 is mounted to the supporting structure via a drive arrangement 158 which is operative to move the lens carriage 118 vertically relative to the supporting structure so that the distance between a test lens 120 mounted in the carriage 118 and the display screen 114 can be changed. The drive arrangement 158 includes a vertically aligned threaded shaft 160 driven by a stepper motor 162, both of which are supported on the supporting structure. The stage 154 is mounted to the shaft 160 by means of a drive nut 164 such that rotation of the shaft 160 by the motor 162 causes the lens carriage 118 to move linearly in a vertical direction parallel to the optical axis of the camera.

The apparatus 110 includes an electronic control system (not shown) similar to that described above in relation to the first embodiment and which includes a computing device having memory and processing means. The computing device is operatively connected with the display screen 114 and the digital camera 116 and is programmed and configured to generate and display test patterns on the display screen 114, to capture images of the displayed test patterns using the digital camera 114 and to process and analyse the captured images according to the methodology described above. The computing device is also operatively connected with the drive arrangement 158 to control operation of the stepper motor 162 in order to move the lens carriage 118 between first and second positions in accordance with the method. In the present embodiment, the pitch of the drive shaft 160 is known and so the computing device is able to accurately calculate the change in lens distance Δdl between the first and second positions from the number of steps made by the motor 162 during this movement.

In use, a test lens 120 is placed in the lens carriage 118 so that it is aligned between the camera and the display screen 114 on the optical axis X of the camera. A suitable test pattern is displayed on the screen 114 and the lens carriage 118 moved to a first position or measurement plane (as shown on the left in FIG. 4) at which the test lens is at a first lens distance dl¹ from the display screen. With the test lens at the first position, an image of the displayed test pattern seen through the test lens is captured by the camera (the first lens image test pattern) and the first lens image test pattern is analysed by the computing device in comparison to the original test pattern to determine the magnitude of magnification M₁ produced by the test lens at the first position.

The lens carriage 118 is then moved to a second position or measurement plane (as shown on the right in FIG. 4) at which the test lens is at a second lens distance dl² from the screen 114 different from the first lens distance dl¹. With the carriage 118 at the second position, a second image of the displayed test pattern as seen through the test lens is captured by the camera (the second lens image test pattern) and the second lens image test pattern image analysed in comparison with the original test pattern by the computing device to determine the magnitude of magnification M₂ produced by the test lens 120 at the second position. The computing means is then able to determine the power of the test lens from the magnification values M₁, M₂ and the change in lens distance Δdl using the methodology described above, e.g. using equation 1 or an equivalent.

Whilst not shown in the drawings, the apparatus 110 has an outer casing mounted to the supporting structure to enclose the internal components. The outer causing includes an access panel or door which is openable to allow access to the male cartridge 156 to enable a test lens to be mounted in the device for examination and subsequently removed. The apparatus also has a second display screen which is visible externally for displaying information to a user and a user interface. The second display screen is operatively connected with the computing device and used to display information which may include instructions and/or results of the lens examination. The second display screen can also be used to enable a user to provide inputs to the apparatus and could be a touch screen. The user interface could include a key pad or other user input device.

The method and apparatus 10, 110 as described above can utilise a number of different test patterns and methods of analysing the test patterns to determine magnification as are known in the art. However, the method and apparatus are especially suitable for use with the test pattern and methods of analysis disclosed in WO 2018/073577A2. These will be described briefly below but the reader should refer to WO 2018/073577A2 for further details.

In the following description, the term “ellipse” should be understood as encompassing a circle, which is a special case of an ellipse in which the major and minor axes are equal.

FIG. 5 illustrates a first embodiment of a test pattern which can be used in the method and apparatus of the invention. In this embodiment, the test pattern 370 comprises at least one set 372 of dots 374 which can be joined by a unique first ellipse 376 of best fit, in which the major axis R₁ and minor axis R₂ are equal (in other words, a circle or circular ellipse) as illustrated in FIG. 2. Whilst the dots 374 may be circular, this is not essential and the term “dots” should be understood as encompassing any mark which can be used to indicate a point on the circumference (perimeter) of an ellipse regardless of shape unless otherwise stated.

Any number of dots 374 capable of defining a unique ellipse can be used in the set 372. However, advantageously a minimum number of dots which defines the ellipse with sufficient accuracy is used in each set 372 as this reduces the number of data points that must be analysed and so reduces processing time. In tests, it has been found that an ellipse can be defined with sufficient accuracy using a set of six dots 374 arranged at the apexes of a notional regular hexagon. However, a set 372 comprising five dots or more than six dots could be used.

As illustrated in FIG. 5, the test pattern can have an additional dot 374a at the centre of the set. The central dot 374a does not form part of the set but may be helpful in accurate positioning of the set relative to the test lens and/or axis X of the camera. However, the additional central dot 374a is not essential and could be omitted.

The test lens 22, 122 will usually distort the test pattern 370 (unless it is a plain lens), so that in the test pattern in the lens images, the spacing between the dots will increase or decrease depending on the magnitude of magnification. For a magnification greater than 1, the spacing between the dots increases whilst for magnification less than 1 the spacing between the dots decreases. With a spherical lens, the spacing between the dots changes by the same amount in all directions so that the major and minor axes of an ellipse of best fit joining the dots of the set in the distorted test pattern will be equal. However, a cylindrical lens will vary the spacing between the dots by different amounts in different directions. As a result, the major and minor axes of an ellipse of best fit joining the dots of the set in the distorted test pattern in the lens images will not be equal. Accordingly, by comparing the major and minor axes of an ellipse of best fit defined by the set of dots in the distorted test pattern in each of the lens images with the major and minor axes of an ellipse defined by the set of dots in the original test pattern, it is possible to determine the magnification of the test pattern and, where present, astigmatic correction (cylindrical power) and the axis of the astigmatic correction.

### Example 1

FIG. 6 illustrates a distorted test pattern 370′ in a lens image captured by the camera for a cylindrical lens. The dots 374′ in the set 372′ can be joined by a second ellipse of best fit 376′, and the computer determines a major axis R₁’ and a minor axis R₂’ of the second ellipse 376′ and compares these with the major axis R₁ and minor axis R₂ of a first ellipse 76 defined by the set of dots in the original test pattern 370 as illustrated below:

| | | |
|---|---|---|
| R₁ = 100 | R₁’ = 50 | Magnification = 0.5 |
| R₂ = 100 | R₂’ = 50 | Magnification = 0.5 |

In this example, since the lens is spherical, the set 372′ of dots 374′ in the distorted pattern 370′ define an ellipse in which the major and minor axes R₁’ and R₂’ are equal.

### Example 2

FIG. 7 illustrates a distorted test pattern 370′ in a lens image for a cylindrical lens. The dots 374′ in the distorted set 372′ can be joined by a second ellipse 376′ of best fit and the computer determines a major axis R₁’ and a minor axis R₂’ of the second ellipse 376′ and compares these with the major axis R₁ and minor axis R₂ of a first ellipse 376 defined by the set of dots in the original test pattern 370 as illustrated below:

| | | |
|---|---|---|
| R₁ = 100 | R₁’ = 100 | Magnification = 1 |
| R₂ = 100 | R₂’ = 50 | Magnification = 0.5 |

In this example where the lens is cylindrical, the dots 374′ in the distorted pattern define an ellipse in which the major axis R₁’ and the minor axis R₂’ are not equal, indicating that the lines has distorted the test pattern by different amounts in different directions. The axis angle of the cylindrical lens can also be calculated by the computer from the direction of the major and minor axes.

The apparatus may be configured to use the test pattern described above in a spot mode to determine the power and other optical parameters at a single point in the test lens or in a mapping mode to determine the power and other optical parameters at a number of locations over the whole of the test lens, or at least within an area of interest of the test lens.

### Mapping Mode

In the mapping mode, the original test pattern displayed on the screen 14 comprises a number of the sets 372 of dots 374, where the dots in each set 372 can be joined by a first ellipse of best fit having major and minor axes R₁, R₂ that are equal. The sets are spread over the area of the display screen below the test lens and some of the sets 372 may be partially overlapping to ensure that a sufficient number and density of sets are provided such that the optical parameters can be determined at the required number of locations. In a particularly advantageous embodiment, the test pattern 370 comprises a plurality of dots 374 arranged in an array 378 as illustrated in FIG. 8. In the array, the dots 374 are arranged in rows and columns, wherein the dots 374 in each row are equally spaced apart by a distance Y which is equal to the spacing Z between adjacent rows, and wherein alternate rows are off-set so that the dots 374 in any given row lie midway between the dots in an adjacent row or rows. In this test pattern array 378, each dot 374 (other than those at the edges of the array) is surrounded by six other dots 374 which are located at the apexes of a notional regular hexagon. The six surrounding dots form a set 372 that can be joined by a first ellipse 376 of best fit having major axis R₁ and a minor axis R₂ that are equal. This test pattern 370 can be used to determine the power of the test lens at different locations over the whole of the test lens, or an area of interest of the test lens, by carrying out the above analysis for each hexagonal set 372 of dots 374 within the area of interest. Accordingly, the computing device running suitable software determines a major axis R₁’ and a minor axis R₂’ for a second ellipse 376′ of best fit through the dots in each hexagonal set 372 of dots in the distorted test pattern within the area of interest from the lens image data and compares these with the major axis R₁ and minor axis R₂ respectively of a first ellipse derivable from the corresponding set 372 of dots in the original test pattern. In the original test pattern, every hexagonal set 372 of dots defines a first ellipse 376 of the same size so that the maj or and minor axes R₁, R₂ are the same for every hexagonal set 372 of dots in the original test pattern. Accordingly, it is not necessary to actually generate an ellipse and determine the major and minor axes for every hexagonal set 372 of dots in the original test pattern. The computer may only determine the major axis R₁ and minor axis R₂ for one set or a sample number of the sets. Indeed, data for the major axis R₁ and minor axis R₂ of the first ellipses in the original test pattern may be saved as data in the computer.

The test pattern 370 as illustrated in FIG. 8 provides a convenient way of presenting a large number of sets of dots evenly distributed across the area of interest. Because they are interlinked and partially overlapping, the sets defined in the array are highly concentrated allowing for a detailed analysis of the characteristics of the test lens within the area of interest. Each set of dots 372 is used to determine the power and other optical parameters of the test lens at the position occupied by that set.

The results of the analysis are conveniently displayed by means of a graphical representation of the test lens in which the power and optical parameters are displayed in the form of a colour contour map.

Use of the mapping mode provides for a fully automated system of examining a test lens which does not require the user to select a number of locations for examination and reposition the test lens for each measurement.

### Spot Mode

The spot mode is used to find the optical parameters of the test lens at one position only, usually at the optical centre of the test lens.

In this mode, only one set of dots 372 defining an ellipse in which the minor and major axes are equal is used as a test pattern as illustrated in FIG. 2. In carrying out the spot mode method, the centre of the test pattern 372 is aligned with the optical centre of the test lens and the optical axis X of the camera lens and the camera used to capture an image of the distorted test pattern 370′ through the test lens at each position. The analysis as described above is then carried out for the single set of dots only to determine the power of the test lens at that point. This method could though be used to determine the optical parameters of a test lens at a single position other than the optical centre.

The displayed test pattern used in the spot mode may be a sub-set of the array 378 used in the mapping mode including one central dot surrounded by six dots at the apexes of the notional hexagon. This is advantageous in enabling the system 10 to use the same grid pattern or part thereof in both modes. However, the central dot is not essential and could be omitted in the spot mode.

It is not essential that the test pattern be displayed on a digital screen and it could be displayed in other ways such as on printed media forming the display surface. However, the use of a digital display screen, such as the screen 14 of the systems 10 is advantageous as the test pattern can be changed dynamically.

For the majority of ophthalmic lenses, determining the power of a lens using magnification values obtained at two different measurement planes and the distance between the planes does not require a function F to be developed for the lensmeter using a set of standard lenses of known dioptric power. Thus, any errors introduced from the use of the standard lenses and in determining the function are avoided. Furthermore, calibration of the apparatus is not generally required since any effect on the test pattern produced by the apparatus will be present in both the first and second lens image test patterns and so taken into account when determining the value of the magnification.

The above embodiments are described by way of example only. Many variations are possible without departing from the scope of the invention as defined in the appended claims and statements of invention.

1. A method of determining the power of a lens, the method comprising:
a. displaying a test pattern on a planar display surface;
b. positioning a test lens between the display surface and a digital camera at a first position where the test lens is at a first lens distance from the display surface and using the camera to capture an image of the test pattern as seen through the test lens in a first lens image (“the first lens image test pattern”);
c. positioning the test lens between the display surface and the camera at a second position where the test lens is at a second lens distance from the display surface different from the first lens distance and using the camera to capture an image of the test pattern as seen through the test lens in a second lens image (“the second lens image test pattern”);
d. analysing each of the first and second lens image test patterns to determine the magnitude of magnification M₁ of the test pattern at the first position and the magnitude of magnification M₂ of the test pattern at the second position;
e. calculating the power P of the test lens from the magnification values M₁, M₂ at the first and second positions respectively and the change Δdl in the lens distance between the first and second positions.

2. A method of determining the power of a test lens as claimed in claim 1 wherein the power P of the test lens is determined using the following equation or an equivalent:
$$P = \frac{1}{f} = \frac{\frac{1}{{M}_{1}} - \frac{1}{{M}_{2}}}{△ d l}$$
where M₁ and M₂ are the values of the magnification determined at the first and second positions respectively and Δdl is the change in lens distance between the first and second positions.

3. A method of determining the power of a test lens as claimed in claim 1, wherein the method comprises moving the test lens by a predetermined amount Δdl from the first position to the second position.

4. A method of determining the power of a test lens as claimed in claim 1, wherein the method comprises moving the test lens from the first position to a second position where at least a predetermined change in magnification of the test pattern when compared with the magnification at the first position is present and determining the change in lens distance Δdl between the first and second positions.

5. A method of determining the power of a test lens as claimed in claim 1, wherein the method comprises monitoring the position of the test lens, either directly or indirectly, in order to determine the change in lens distance Δdl between the first and second positions.

6. A method of determining the power of a test lens as claimed in claim 1, wherein the method comprises mounting the test lens in a lens carriage for holding the test lens between the display surface and the camera and wherein the lens carriage is movable relative to the display surface in a linear direction perpendicular to the display surface to vary the lens distance of a test lens mounted to the lens carriage in use.

7. A method of determining the power of a test lens as claimed in claim 6 wherein the method comprises moving the lens carriage in said linear direction to place the test lens at the second position after the first lens image test pattern has been captured.

8. A method of determining the power of a test lens as claimed in claim 7 wherein the method comprises determining the change in lens distance Δdl between the first and second positions from the movement of the lens carriage.

9. A method of determining the power of a test lens as claimed in claim 1, wherein the method is used to determine the lens power at multiple locations within an area of interest of the test lens.

10. Apparatus for determining the power of a test lens, the apparatus comprising a planar display surface for displaying a test pattern, a digital camera having a lens whose optical axis is aligned perpendicular to the display surface, a lens carriage for holding a test lens between the display surface and the camera lens, the lens carriage being movable in a linear direction perpendicular to the display surface to vary the distance between the test lens and the display surface, the apparatus including an electronic control system for controlling movement of the lens carriage in said linear direction.

11. Apparatus as claimed in claim 10 comprising an electronic actuator operating under the control of the electronic control system for controlling movement of the lens carriage.

12. Apparatus as claimed in claim 11, wherein the actuator comprises a stepper motor.

13. Apparatus as claimed in claim 10, the apparatus comprising a system for measuring or detecting movement in said linear direction by the lens carriage.

14. Apparatus as claimed in claim 10, the apparatus being configured in use to move the lens carriage to a first position the test lens mounted to the carriage is at a first lens distance from the display surface and to subsequently move the lens carriage to a second position in which the test lens is at a second lens distance from the display surface different to the first lens distance.

15. Apparatus as claimed in claim 10, wherein the apparatus is configured in use to use the digital camera to capture an image of the test pattern as seen through the test lens by the camera when the lens carriage is at the first position (“the first lens image test pattern”) and to capture a further image of the test pattern as seen through the test lens by the camera when the lens carriage is at the second position (“the second lens image test pattern”) and to analyse each of the first and second lens image test patterns to determine the magnitude of magnification of the test pattern at the first position and the second position respectively.

16. Apparatus as claimed in claim 15 the apparatus being configured to move the lens carriage by pre-determined distance between the first and second positions.

17. Apparatus as claimed in claim 15 the apparatus being configured to move the lens carriage from the first position until a second position is reached at which the change in magnification of the test pattern is at or above a pre-determined amount and to determine the distance moved by the lens carriage from the first position to the second position.

18. Apparatus as claimed in claim 15, the apparatus comprising a computing device which forms part of or is associated with the electronic control system and which computing device is programmed to carry out the image data processing and analysis steps for determining the magnitude of magnification of the test pattern at the first position and the second position.

19. Apparatus as claimed in claim 10, the apparatus comprising computing means programmed to carry out the image processing and analysis steps of the method comprising:
a. displaying a test pattern on a planar display surface;
b. positioning a test lens between the display surface and a digital camera at a first position where the test lens is at a first lens distance from the display surface and using the camera to capture an image of the test pattern as seen through the test lens in a first lens image (“the first lens image test pattern”);
c. positioning the test lens between the display surface and the camera at a second position where the test lens is at a second lens distance from the display surface different from the first lens distance and using the camera to capture an image of the test pattern as seen through the test lens in a second lens image (“the second lens image test pattern”);
d. analysing each of the first and second lens image test patterns to determine the magnitude of magnification M1 of the test pattern at the first position and the magnitude of magnification M2 of the test pattern at the second position;
e. calculating the power P of the test lens from the magnification values M1, M2 at the first and second positions respectively and the change Δdl in the lens distance between the first and second positions.

20. Apparatus for determining the power of a test lens, the apparatus comprising a planar display surface for displaying a test pattern, a digital camera having a lens whose optical axis is aligned perpendicular to the display surface, a lens carriage for holding a test lens between the display surface and the camera lens, the lens carriage being movable in a linear direction perpendicular to the display surface to vary the distance between the test lens and the display surface, the apparatus including an electronic control system for controlling movement of the lens carriage in said linear direction, the apparatus being configured to carry out the method according to claim 1.

21. A method of determining the power of a lens by an apparatus comprising a planar display surface for displaying a test pattern, a digital camera having a lens whose optical axis is aligned perpendicular to the display surface, a lens carriage for holding a test lens between the display surface and the camera lens, the lens carriage being movable in a linear direction perpendicular to the display surface to vary the distance between the test lens and the display surface, the apparatus including an electronic control system for controlling movement of the lens carriage in said linear direction, the method comprising:
a. displaying a test pattern on a planar display surface;
b. positioning a test lens between the display surface and a digital camera at a first position where the test lens is at a first lens distance from the display surface and using the camera to capture an image of the test pattern as seen through the test lens in a first lens image (“the first lens image test pattern”);
c. positioning the test lens between the display surface and the camera at a second position where the test lens is at a second lens distance from the display surface different from the first lens distance and using the camera to capture an image of the test pattern as seen through the test lens in a second lens image (“the second lens image test pattern”);
d. analysing each of the first and second lens image test patterns to determine the magnitude of magnification M1 of the test pattern at the first position and the magnitude of magnification M2 of the test pattern at the second position;
e. calculating the power P of the test lens from the magnification values M1, M2 at the first and second positions respectively and the change Δdl in the lens distance between the first and second positions.
